(19) United States
(12) Patent Application Publication
(10) Pub. No.: US 2026/0092242 A1
(43) Pub. Date: Apr. 2, 2026

(54) Method for Producing an Alcoholic Beverage Comprising of Distilled Alcohol and Harnup

(71) Applicants: Michael Tava, Snohomish, WA (US); Mehmet Tava, Oberursel (DE)

(72) Inventors: Michael Tava, Snohomish, WA (US); Mehmet Tava, Oberursel (DE)

(21) Appl. No.: 18/905,131

(22) Filed: Oct. 2, 2024

(51) Int. Cl. C12G 3/07; C12H 1/07; C12H 1/22; C12H 6/02

(52) U.S. Cl. CPC C12G 3/07; C12H 1/063; C12H 1/22; C12H 6/02

(57) ABSTRACT

The invention provides a novel alcoholic beverage called “Bogma,” which combines distilled alcohol and harnup (carob). The beverage offers a unique flavor profile resulting from the natural properties of harnup, and it may be produced using various methods, including the infusion of dried or powdered harnup into distilled alcohol. The invention further describes different ingredient ratios, aging processes, and optional flavor enhancements, creating a drink that is distinctive in both taste and production.

### CROSS-REFERENCE TO RELATED APPLICATIONS

Traditional methods of alcoholic beverage production often involve fermentation and distillation of specific raw materials to yield a wide variety of drinks with varying characteristics. While the market offers a diverse array of alcoholic beverages, there remains a constant pursuit of innovation to create unique and appealing products that cater to evolving consumer preferences. In recent times, there has been an increasing interest in the use of unconventional ingredients to impart distinct flavors to alcoholic beverages. Carob, also known as harnup, is derived from the pods of Ceratonia siliqua, is an example of such an ingredient. Known for its natural sweetness and rich, earthy undertones, ceratonia siliqua has found applications in the food industry but remains relatively unexplored in the realm of alcoholic beverages.

### BACKGROUND OF THE INVENTION

This invention relates to an alcoholic beverage that combines distilled alcohol with harnup (carob), a natural ingredient derived from the carob tree, to create a novel drink called “Bogma.” The beverage offers unique flavor characteristics and potential health benefits due to the inclusion of harnup, which is known for its nutritional content.

### SUMMARY OF THE INVENTION

The present invention introduces a novel method for producing an alcoholic beverage, herein referred to as bogma, which stands out for its infusion of raw ground carob. The process involves fermenting grapes for a specific duration, followed by a meticulous distillation process to produce a clear alcohol with a targeted proof. The innovation lies in the incorporation of raw ground carob pods into the distilled alcohol, allowing the mixture to mature for a defined period to achieve a perfected flavor profile. The final step involves removing the carob from the mixture through a specialized filtration process, resulting in the creation of the Bogma drink.

### BRIEF DESCRIPTION OF DRAWINGS

FIG. 1 is a flowchart illustrating a method for producing an alcoholic beverage, according to some embodiments of the present disclosure.

### DETAILED DESCRIPTION OF THE INVENTION

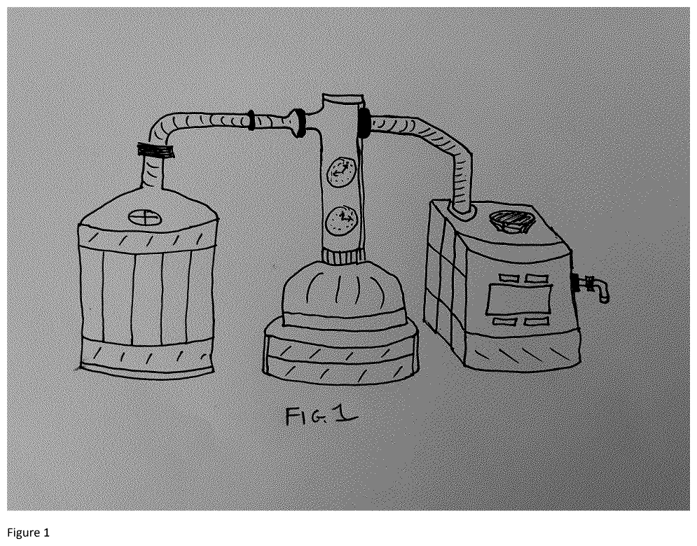

FIG. 1 is a flowchart that describes a method for producing an alcoholic beverage, according to some embodiments of the present disclosure. In some embodiments, the method may include fermenting grapes for 30 to 60 days. At 120, the method may include mixing raw ground carob pods into the clear alcohol. At 130, the method may include allowing the distilled alcohol and ground carob mixture to sit for 15 days to achieve a perfected flavor profile. At 140, the method may include removing the ground carob from the mixture by filtering through a filtering machine to produce an alcoholic beverage named bogma. At 160, the method may include a process for enhancing the flavor of an alcoholic beverage, comprising adding raw ground carob to the beverage during production.

In some embodiments, heating and distilling the fermented grapes to produce a clear alcohol with 90% proof. The fermented grapes may be of a specific grape variety known for its suitability in alcoholic beverage production. The ground carob pods may be mixed in a predetermined ratio with the clear alcohol. The method of claim 1, further comprising adding additional flavorings or additives during the mixing step.

In some embodiments, the method of claim 1. The step of removing the carob may be carried out by a multi-stage filtration process. An alcoholic beverage produced according to the method of claim 1. The beverage may have a unique flavor profile resulting from the incorporation of raw ground carob. The clear alcohol may be produced with a specific proof between 80% and 95%.

In some embodiments, a distilled alcohol infused with raw ground carob, the raw ground carob imparting a distinct flavor to the alcohol. The raw ground carob may be present in the alcohol in a concentration of about 5% to about 20% by weight. The alcoholic beverage may be bogma. The raw ground carob may be added in the form of a paste or powder.

In some embodiments, a method of producing a raw ground carob-infused alcoholic drink, comprising fermenting grapes, distilling the fermented grapes, mixing raw ground carob into the distilled alcohol, and filtering the mixture to produce the alcoholic beverage named Bogma. The method of claim 15. The fermented grapes may be fermented for 30 to 60 days. A kit for making a raw ground carob-infused alcoholic beverage, comprising a container of raw ground carob and a bottle of distilled alcohol.

Recently, the alcohol industries have seen a rise in alcoholic beverages targeting unique flavor mixtures. Given the health benefits associated with harnup, an alcoholic drink containing this ingredient is seen as advantageous for health and enjoyment purposes. Historically, harnup liquor has been consumed in the Andes region for health maintenance. However, the distinctive odor of harnup in such beverages does not appeal to modern tastes, limiting its popularity.

The objective of this invention is to create an alcoholic beverage with harnup extract that retains its beneficial properties, has a reduced harnup odor, and is pleasant to drink.

To achieve this, the inventors conducted thorough research and discovered that using a distilled liquor primarily made from fermented muscat grapes as a base alcohol, combined with harnup extract and a specific amount of acetic acid, effectively masks the harnup odor. This approach results in a harnup extract-containing alcoholic beverage with minimal harnup odor, leading to the successful development of this invention.

The present invention offers an alcoholic beverage featuring harnup extract with notable benefits. This harnup extract-based drink is designed to be easy to consume because it effectively masks the characteristic odor of harnup. This innovative beverage is a significant advancement as it caters to beauty and health-conscious consumers, by being easy to enjoy.

The harnup extract-containing alcoholic beverage of this invention (referred to hereafter as “harnup extract beverage”) is primarily created by adding ground harnup to a distilled liquor made predominantly from fermented muscat grapes. This liquor contains between 1 to 400 ppm of acetic acid relative to the amount of pure alcohol it contains.

There are no strict limitations on the solvent-to-harnup ratio used for extraction. Ideally, the solvent should be 0.3 to 5,000 times the weight of the harnup. For better operational efficiency and extraction effectiveness, a solvent amount of 5 to 100 times the weight of the harnup is preferred.

The quantities of raw materials for the harnup extract-containing alcoholic beverage are not rigidly defined. Typically, 0.5 to 1,000 parts by weight of distilled liquor (mainly fermented muscat grapes, containing 1 to 400 ppm acetic acid relative to the pure alcohol content), 0.3 to 100 parts by weight of distilled grapes, and 0.3 to 100 parts by weight of ground harnup are used for each part by weight (solid matter). The solid matter content of the harnup extract can be determined by measuring the concentrate after solvent removal or calculated from the extract's Brix value.

1. An alcoholic beverage, comprising:
a. A distilled alcohol component; and
b. An extract or infusion of harnup (carob), wherein the distilled alcohol and harnup are combined in a ratio sufficient to provide a distinct flavor profile characteristic of the beverage “Bogma.”

2. The alcoholic beverage of claim 1, wherein the distilled alcohol is selected from the group consisting of vodka, gin, rum, whiskey, and brandy.

3. The alcoholic beverage of claim 1, wherein the harnup extract is prepared by steeping crushed harnup pods in water and then filtering to obtain the extract.

4. The alcoholic beverage of claim 1, wherein the ratio of distilled alcohol to harnup extract ranges from 70:30 to 90:10 by volume.

5. The alcoholic beverage of claim 1, wherein the harnup component is dried and ground carob pods mixed with the distilled alcohol to form a flavored infusion.

6. The alcoholic beverage of claim 5, wherein the ground or powdered carob is optionally roasted before mixing with the distilled alcohol.

7. The alcoholic beverage of claim 1, wherein the beverage has an alcohol content of 20% to 40% by volume.

8. The alcoholic beverage of claim 1, wherein the beverage is aged for at least 30 days to develop its flavor.

9. The alcoholic beverage of claim 8, wherein the optional wooden barrels are made from oak, chestnut, or cherry wood.

10. The alcoholic beverage of claim 1, further comprising an optional natural sweetener selected from the group consisting of honey, agave syrup, or stevia.

11. The alcoholic beverage of claim 1, wherein the harnup extract contributes a caramel, nutty, or chocolate-like flavor to the final beverage.

12. The alcoholic beverage of claim 1, wherein the beverage is free from artificial additives or preservatives.

13. The alcoholic beverage of claim 1, further comprising additional botanicals or spices, including vanilla, cinnamon, or anise, to enhance the flavor profile.

14. The alcoholic beverage of claim 1, wherein the distilled alcohol is a neutral pod or optional grain spirit.

15. A method for producing an alcoholic beverage, comprising:
a. providing distilled alcohol;
b. preparing a harnup extract by steeping harnup pods in water;
c. combining the distilled alcohol and harnup extract in a predetermined ratio to form the beverage “Bogma”;
d. optionally aging the mixture in barrels for a period of time to enhance flavor.

16. The method of claim 15, wherein the aging period is between 30 days and 6 months.

17. The method of claim 15, wherein the harnup pods are optionally roasted prior to steeping to enhance the depth of flavor in the final beverage.

18. The method of claim 15, further comprising the step of adding optional natural sweeteners to the beverage before bottling.

19. A method for producing an alcoholic beverage, comprising:
a. steeping dried harnup (carob) powder in distilled alcohol to create a flavored infusion;
b. filtering the infusion to remove solid particles;
c. optionally diluting the infusion with water or additional alcohol to achieve the desired alcohol content;
d. bottling the resulting beverage.

20. The alcoholic beverage of claim 1, when the beverage is carbonated or effervescent.

21. The alcoholic beverage of claim 1, wherein the distilled alcohol is substituted with a low-alcohol or alcohol-free base while maintaining the harnup flavor profile.
